(19) United States
(12) Patent Application Publication
(10) Pub. No.: US 2008/0154737 A1
(43) Pub. Date: Jun. 26, 2008

(54) COMPUTER-ASSISTED SALES OF AFTER-MARKET MOTOR VEHICLE PRODUCTS

(75) Inventor: Jason N. Linkswiler, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/614,610

(22) Filed: Dec. 21, 2006

(51) Int. Cl. G06Q 30/00

(52) U.S. Cl. 705/26

(57) ABSTRACT

In general, techniques are described of identifying and marketing a set of after-market motor vehicle products for a customer during a sales process using one or more computers. In some example embodiments, a computer kiosk collects a set of customer preference information regarding after-market motor vehicle products from a customer. A business logic server may then process the customer preference information to identify a set of after-market motor vehicle products that the customer may be interested in purchasing with a motor vehicle. The customer may then select which ones of the identified after-market products to purchase with the motor vehicle.

### TECHNICAL FIELD

The invention relates to automotive produces, and particularly to sales of automotive products.

### BACKGROUND

In general, when a customer is interested in purchasing a new automobile, the customer goes to a dealership. When the customer arrives at the dealership, a sales representative at the dealership begins to collect information about the customer's interests, background, finances, and so on. The sales representative may collect this information by observing which car models the customer is interested (e.g., sports cars, SUVs, sedans, etc.), by observing demographic information of the customer (e.g., age, race, apparent income level), and so on. In addition, the sales representative may ask the customer questions in an attempt to obtain such information. The sales representative may make these observations and ask these questions in the dealership showroom or during a test drive. When the customer has decided on a car model, the sales representative may verbally convey this information about the customer to a finance and insurance manager.

The finance and insurance manager may use the information collected by the sales representative to attempt to sell additional after-market products to the customer along with the automobile. An after-market product for an automobile is a product that is added to or associated with the automobile after a manufacturer of the automobile completes the vehicle. Examples of after-market products include physical products such as mud flaps, window tinting, paint protection, truck caps, bed liners, stain protection, and so on. In addition, after-market products may be financial or contractual in nature. For example, after-market products may include extended service agreements, extended warranties, insurance policies, and so on. The finance and insurance manager may also attempt to determine price levels at which the customer might be willing to buy the after-market products.

As part of the sales process, the sales representative introduces the customer to the finance and insurance manager to complete the purchase of the vehicle. At this time, the finance and insurance manager may attempt to convince the customer to buy one or more of the after-market products. After the customer decides whether to buy the identified after-market products, the finance and insurance manager completes any finance and insurance arrangements with the customer. Once the finance and insurance manager completes the finance and insurance arrangements, the customer may sign a purchase agreement to complete the sale.

### SUMMARY

In general, the invention is directed to computer-aided techniques of identifying and marketing a set of after-market motor vehicle products for a customer during a sales process using one or more computers. In some example embodiments, a computer kiosk collects from a customer a set of customer preference information regarding after-market motor vehicle products. A business logic server may then process the set of customer preference information to automatically identify a set of recommended after-market motor vehicle products that the customer may be interested in purchasing along with a motor vehicle. The customer may then select which ones of the identified after-market products to purchase with the motor vehicle.

For example, a customer may visit a motor vehicle dealership with a primary purpose of purchasing a motor vehicle. While the customer is visiting the dealership, the customer may interact with a computer kiosk that collects one or more pieces of information related to product preferences of the customer. The kiosk may transmit such preference information to a centralized business logic server through a computer network. The business logic server may apply one or more business rules to the preference information to identify a recommended set of after-market motor vehicle products in which the customer is likely to be interested. Subsequently, when the customer is finalizing the purchase of the motor vehicle at the dealership, a separate computer console may display descriptions and prices of the recommended set of after-market automotive products identified by the business logic server. The customer may use the computer console to make purchasing decisions regarding the after-market motor vehicle products.

In one embodiment, a method comprises collecting, from a customer during a sales process for a motor vehicle, a set of customer preference information regarding after-market motor vehicle products using a kiosk installed in a motor vehicle dealership. The method also comprises processing the collected set of customer preference information with a server to automatically identify a set of after-market motor vehicle products that the customer is likely to be interested in purchasing along with the motor vehicle. In addition, the method comprises displaying, with a customer console, the identified set of after-market motor vehicle products. The method also comprises collecting, with the customer console, customer purchase information that describes which after-market motor vehicle products the customer chose to purchase along with the motor vehicle.

In another embodiment, a system comprises a computer kiosk to collect from a customer a set of customer preference information regarding after-market motor vehicle products during a sales process for a motor vehicle. The computer kiosk is installed in a motor vehicle dealership. The system also comprises a business logic server to use the collected set of customer preference information to automatically identify a set of after-market motor vehicle products that the customer is likely to be interested in purchasing along with the motor vehicle. In addition, the system includes a customer console to display the identified set of after-market motor vehicle products and to collect customer purchase information that describes which after-market motor vehicle products the customer chose to purchase along with the motor vehicle. The system also comprises a computer network to facilitate communication among the kiosk, the business logic server, and the customer console.

In another embodiment, a motor vehicle dealership comprises a computer kiosk to collect from a customer a set of customer preference information regarding after-market motor vehicle products during a sales process for a motor vehicle, wherein the computer kiosk is installed in a motor vehicle dealership. The dealership also comprises a business logic server to use the collected set of customer preference information to automatically identify a set of after-market motor vehicle products that the customer is likely to be interested in purchasing along with the motor vehicle. In addition, the dealership includes a customer console to display the identified set of after-market motor vehicle products and to collect customer purchase information that describes which after-market motor vehicle products the customer chose to purchase along with the motor vehicle. The dealership also includes a computer network to facilitate communication among the kiosk, the business logic server, and the customer console.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary system of dealerships and dealership support servers that automatically identifies packages of after-market motor vehicle products for individual customers.

FIG. 2 is a block diagram illustrating an exemplary system of electronic devices to identify and market a set of recommended after-market motor vehicle products during a sales process.

FIG. 3 is a diagram illustrating an exemplary environment for a finance and insurance office of a motor vehicle dealership.

FIG. 4 is a block diagram illustrating an exemplary business logic server to identify sets of after-market motor vehicle products for a customer using one or more business rules.

FIG. 5 is a flowchart illustrating an exemplary sales process.

FIG. 6 is a flowchart illustrating an exemplary operation of a kiosk.

FIG. 7 is a screenshot illustrating an exemplary welcome screen presented by the kiosk.

FIG. 8 is a screenshot illustrating an exemplary after-market motor vehicle product menu view presented by a kiosk.

FIG. 9 is a screenshot illustrating an exemplary product detail view presented by the kiosk.

FIG. 10 is a screenshot illustrating an exemplary view that prompts the customer to decide whether to associate a name with the set of customer preference information for a current kiosk session.

FIG. 11 is a screenshot illustrating an exemplary view presented by the kiosk that shows a keyboard.

FIG. 12 is a screenshot illustrating an exemplary session selection view presented by a finance and insurance manager console.

FIG. 13 is a screenshot illustrating an exemplary product package view presented by the finance and insurance customer console.

### DETAILED DESCRIPTION

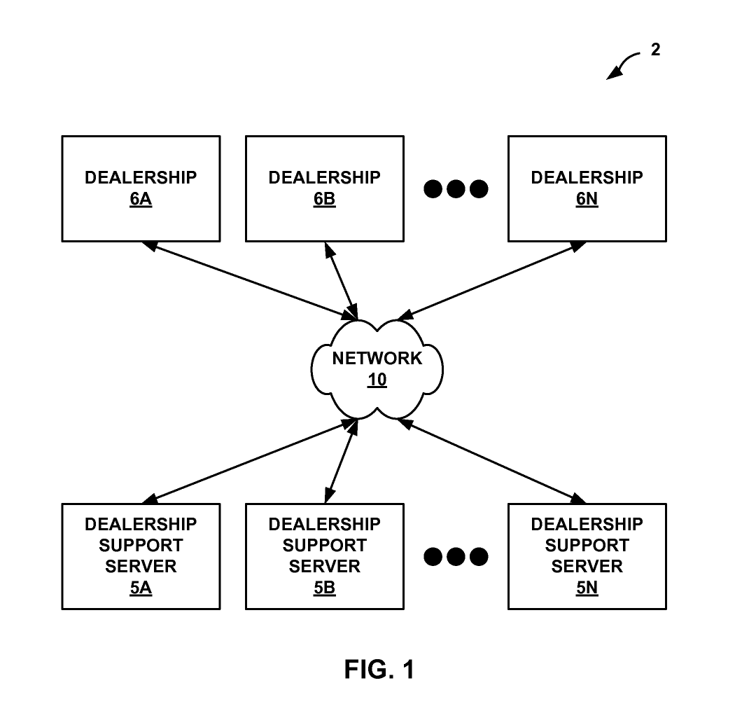

FIG. 1 is a block diagram illustrating an exemplary system 2 of dealerships and dealership support servers that automatically identifies packages of after-market motor vehicle products for individual customers. As illustrated in the example of FIG. 1, system 2 includes a set of motor vehicle dealerships 6A through 6N (collectively, “dealerships 6”). Each of dealerships 6 may be geographically distributed throughout a region, country, or the world. In addition, system 2 includes a set of dealership support servers 5A through 5N (collectively, “dealership support servers 5”). Dealership support servers 5 may be centralized in a network data center or may be geographically distributed. System 2 also includes a network 10 to facilitate communication among dealerships 6 and dealership support servers 5. Network 10 may be a wide-area network, such as the Internet.

As explained in detail below, dealership support servers 5 may receive customer preference information from dealerships 6. Dealership support servers 5 may then use the received customer preference information from one or all of dealerships 6 to identify recommended after-market motor vehicle products for individual customers at each of dealerships 6.

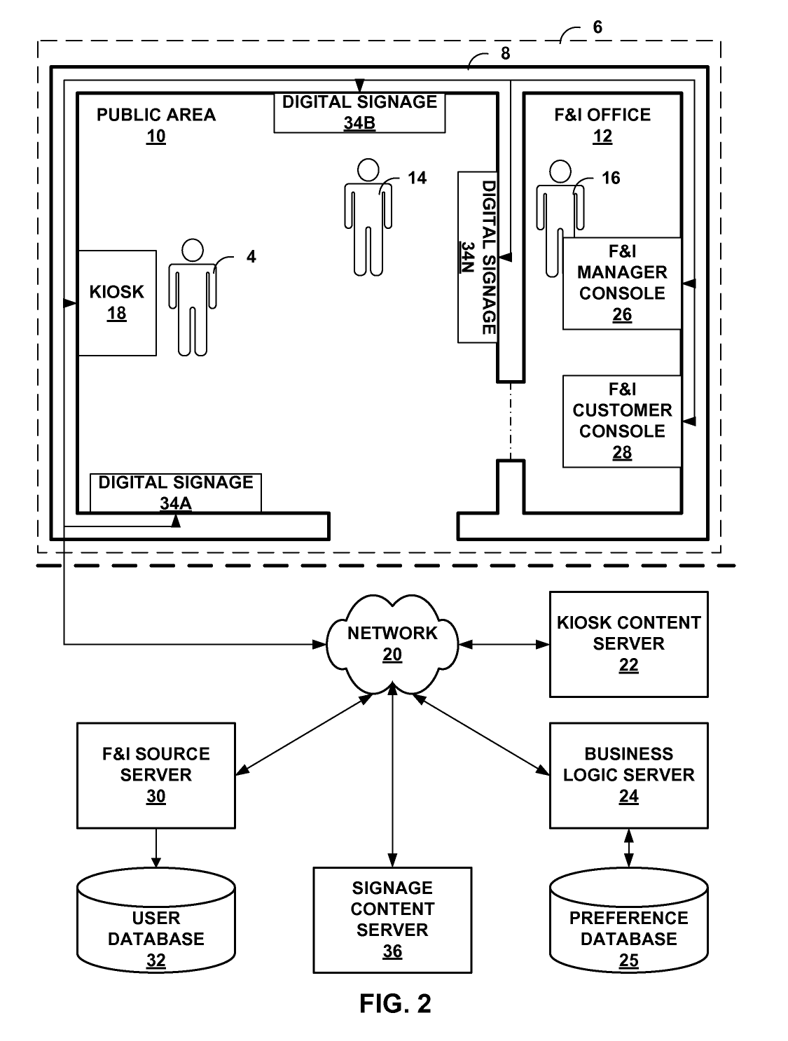

FIG. 2 is a block diagram illustrating an exemplary system 2 of electronic devices to identify and market a set of after-market motor vehicle products during a sales process. For purposes of explanation, this disclosure explains FIG. 2 and subsequent figures in reference to dealership 6A. However, each of dealerships 6 may be similar to dealership 6A in form and function.

As illustrated in FIG. 2, dealership 6A may be housed in a physical building 8 or area of a physical building. Building 8 may include a public area 10 and a finance and insurance (F&I) office 12 (not shown to scale). Public area 10 may be a showroom, a waiting area, a lobby, or otherwise. F&I office 12 may be a private office in which an F&I manager and a customer 4 may conclude a sale of a motor vehicle sold by dealership 6A.

Customer 4 may physically visit dealership 6A for the primary purpose of purchasing or preparing to purchase a motor vehicle or a service related to a motor vehicle that dealership 6A sells. For example, customer 4 may visit dealership 6A for the primary purpose of purchasing an automobile, a watercraft, a recreational vehicle, an all-terrain vehicle, a motorcycle, or other type of motor vehicle commonly purchased by the general public.

When customer 4 visits dealership 6A, a sales representative 14 may greet customer 4 and begin a sales process. This sales process may be divided into a vehicle exploration phase, a negotiation phase, an after-market product exploration phase, and a sale finalization phase. Customer 4 may abort or suspend the sales process at any time before the sales process is complete.

In the vehicle exploration phase of the sales process, sales representative 14 may talk to customer 4, answer the questions of customer 4, take customer 4 for a test drive in a motor vehicle sold by dealership 6A, and so on. In addition, during the vehicle exploration phase, sales representative 14 may directly or indirectly elicit customer preference information from customer 4. In this context, the term “customer preference information” refers to information that may be useful in identifying one or more after-market motor vehicle products that customer 4 may be interested in purchasing along with a motor vehicle. An after-market product for a motor vehicle is a product that is added to or associated with a motor vehicle after a manufacturer of the motor vehicle completes the manufacture of the motor vehicle. After-market products for motor vehicles may be physical or intangible. Examples of physical after-market products may include mud flaps, window tinting, paint protection coatings, truck caps, bed liners, running boards, satellite radios, stain-resistant coatings for interior surfaces, and so on. Examples of intangible after-market products may include extended service agreements, extended warranties, insurance policies, rights to loaner vehicles during service, subscriptions to satellite radio services, subscriptions to navigation services, subscriptions to stranded motorist assistance services (e.g., OnStar™ from General Motors), and so on. The first phase of the sale process may end when customer 4 informs sales representative 14 that customer 4 has made a preliminary decision to purchase a motor vehicle from dealership 6A.

After customer 4 informs sales representative 14 that the customer has made a preliminary decision to purchase a motor vehicle from dealership 6A, sales representative 14 may leave customer 4 for a moment to discuss the preliminary decision with a manager 16 in private. For example, sales representative 14 may leave customer 4 in public area 10 to discuss the preliminary decision with manager 16 in F&I office 12. During these discussions, sales representative 14 may divulge to manager 16 customer preference information learned by sales representative 14 that may be useful in identifying after-market products in which customer 4 may be interested when purchasing the motor vehicle. At the end of these discussions, manager 16 may provide sales representative 14 with negotiation parameters. For example, manager 16 may provide sales representative 14 with a negotiation parameter that sets a lowest price at which sales representative 14 is authorized to sell he motor vehicle.

The negotiation phase of the sales process may begin when sales representative 14 returns to customer 4. During the negotiation phase, customer 4 and sales representative 14 may negotiate a price for the motor vehicle that customer 4 is interested in purchasing. Eventually, customer 4 and sales representative 14 may agree on a price for the motor vehicle and customer 4 may inform sales representative 14 of the customer's intent to purchase the motor vehicle at that price. During the negotiation phase, sales representative 14 may continue to collect customer preference information from customer 4. The negotiation phase of the sales process may end when sales representative 14 reports to manager 16 that customer 4 intends to purchase the motor vehicle from dealership 6A for the negotiated price. In a so-called “haggle-free” sales process the negotiation phase may be omitted.

The after-market product exploration phase of the sales process may begin when sales representative 14 returns to customer 4 and informs customer 4 that manager 16 has agreed to sell the motor vehicle to customer 4 at the negotiated price. In addition, sales representative 14 may inform customer 4 that manager 16 is preparing paperwork regarding the sale. For example, sales representative 14 may inform customer 4 that manager 16 is preparing a finance and insurance report for customer 4. At this point, if customer 4 has not already done so, sales representative 14 may encourage customer 4 to use a computer kiosk 18 located in public area 10 while manager 16 is preparing the paperwork. Customer 4 may also use kiosk 18 without the encouragement of sales representative 14.

Kiosk 18 is an electronic device to collect customer preference information and to present information to customer 4 about after-market motor vehicle products. Kiosk 18 may be a personal computer, a thin-client computer, a laptop computer, a tablet computer, a handheld device, or otherwise. Kiosk 18 may receive user input using a keyboard, a pointing device (e.g., a mouse, trackball, etc.), a touch-sensitive monitor, a microphone to receive voice commands, or otherwise. Kiosk 18 may be housed in an attractive container that identifies kiosk 18 as a source of information on after-market motor vehicle products. A network 20 may facilitate communication between kiosk 18 and a set of additional devices. Network 20 may be a local area network, such as an Ethernet network, a wide area network, such as the Internet, or otherwise. Kiosk 18 may connect to network 20 wired or wireless connections.

To collect customer preference information from customer 4 and to present information to customer 4 about after-market motor vehicle products, kiosk 18 may present a series of one or more views. Kiosk 18 may use one or more software applications to display the views. For example, kiosk 18 may use a web browser software application with a web browser plug-in, such as Flash™ from Abode Macromedia Software, LLC. of San Jose, Calif., to display the views. If kiosk 18 uses a web browser application to present the views, kiosk 18 may retrieve a web page for each view from a kiosk content server 22 on network 20. Alternatively, kiosk 18 may store each view internally. Kiosk content server 22 may be one of dealership support servers 5 and may be a rackmount server platform that executes a hyper-text transfer protocol server. Kiosk content server 22 may send documents to kiosk 18 that describe the views. These documents may be hypertext markup language (HTML) documents, extensible markup language (XML) documents, or otherwise. In each view, kiosk 18 may present text or, in some embodiments, audible sounds that convey the content of each view for purposes of assisting the visually impaired. Furthermore, kiosk 18 may execute locking software to prevent a user from accessing software applications on kiosk 18 other than the application that collects customer preference information and presents after-market product information.

When customer 4 begins a session with kiosk 18, kiosk 18 may present a welcome screen. The welcome screen may be a view that includes the text of one or more preliminary questions and potential answers to the questions. Such preliminary questions may include language selection (e.g., English, Spanish, French, etc.) After customer 4 selects answers to each of the preliminary questions on the welcome screen, kiosk 18 may present a series of question screens. Each question screen may be a view that includes the text of one or more questions and potential answers to the questions. Each question may directly or indirectly elicit customer preference information. For example, one question screen may include the text, “Which one of these vehicles are you interested in?” followed by on-screen buttons that present the names and/or images of motor vehicles available at the dealership. This question may indirectly elicit information relevant to identifying after-market motor vehicle products by eliminating products that would be inappropriate with the selected type of motor vehicle. For example, if customer 4 selects a sports car, the customer is not likely to be interested in products for a pickup truck (e.g., running boards, mud flaps, truck caps, etc.). Other example questions may include, “Do you drive more than 24,000 miles per year?”, “Do you plan on keeping your car for more than three years?”, “Do you think that you will eventually trade in your car?”, “Do you have children?”, and so on. Each of these example questions may be followed by on-screen buttons that represent “Yes” and “No.” Furthermore, each of these questions elicit customer preference information because people who provide similar answers to these question are likely to have similar interests. It may be advantageous for such questions to be phrased in plain and friendly language such that a casual user of kiosk 18 would not find the questions overly personal or invasive.

When customer 4 selects answers to each of the questions on the second question screen, kiosk 18 may present a third question screen with additional questions and answers, and so on. Kiosk 18 may present a variable number of question screens depending on the answers provided by customer 4. Furthermore, kiosk 18 may present differing question screens depending on the answers provided by customer 4. For example, if customer 4 is interested in an SUV, kiosk 18 may present the question, “Do you enjoy driving off-road?” However, if customer 4 is interested in a sports car, kiosk 18 might not present this question because drivers do not usually drive sports cars off-road.

After customer 4 finishes answering the questions presented by kiosk 18, kiosk 18 may transmit the answers to a business logic server 24. Business logic server 24 may be located at dealership 6A or remote from dealership 6A and coupled to a plurality of geographically distributed dealerships 6 (FIG. 1) that are interconnected by one or more computer networks. Business logic server 24 may be one of dealership support servers 5 and may be a rackmount server platform. Business logic server 24 may store the answers in a customer preference database 25, which provides a repository for customer preferences from dealership 6A and optionally the other dealerships.

After storing the answers, business logic server 24 may use the answers to identify a recommended set of after-market motor vehicle products in which customer 4 may be interested. To identify one or more recommended sets (i.e., packages) of after-market products for customer 4, business logic server 24 may apply a set of business rules to the answers. Each business rule may be a condition-action rule. For example, when business logic server 24 receives a set of answers for customer 4 from kiosk 18, business logic server 24 may initialize a set of scores for each available after-market product. The initial scores of the products may be based on answers provided to kiosk 18 and other kiosks by other customers, and otherwise. The action portion of each condition-action rule may increase or decrease the score associated with each available after-market product. For example, one business rule may state, “if the customer is buying a minivan and has children, then increase the score associated with a coating for interior upholstery surfaces that resists stains from spilled food and drinks by ten.” This rule may make sense because customer 4 will likely use the minivan to transport his or her children and children are prone to spilling food and drinks. After business logic server 24 applies the set of business rules to the answers, business logic server 24 may compare the scores for each of the available after-market products. Business logic server 24 may then identify the products with the highest scores as the products in which customer 4 is likely to be interested. Such business rules may be forward-chaining rules that may be compiled into a discrimination network. In another example, business logic server 24 may use other artificial intelligence techniques such as neural networks, Bayesian networks, reinforcement learning, genetic algorithms, and so on.

In addition to identifying individual products, business logic server 24 may identify packages of products in which customer 4 may be interested. A package of products is a set of products that may be sold together as a unit. For example, a business rule may state that if the customer is interested in window tinting, the customer may also be interested in an extended service contract to protect the window tinting. In another example, business logic server 24 may identify a set of packages of products at various price ranges. For instance, a “gold” package may include a large number of products, a “silver” package may include a medium number of products, and a “bronze” package may include a low number of products.

After business logic server 24 identifies after-market motor vehicle products in which customer 4 may be interested, business logic server 24 may send a communication to kiosk 18 that specifies the identified products. Upon receiving this communication, kiosk 18 may present a menu screen that provides a menu from which customer 4 may choose to view screens that describe the products in detail. The menu screen may highlight or otherwise draw attention to the products identified by business logic server 24 as products in which customer 4 is likely to be interested. For example, the menu screen may state that the identified products are “recommended” and present the “recommended” products in a separate row.

When customer 4 selects an after-market motor vehicle product from the menu view presented by kiosk 18, the kiosk may present a product description view that describes the selected product in detail. For example, a view may contain text that describes the product, a photograph or video of the product, and so on. Furthermore, the product description view may include an input feature by which customer 4 may optionally express a level of his or her interest in the product described by the product description view. For example, the input feature may be a slide bar, a set of buttons, a set of radio buttons, a text field, or otherwise.

If customer 4 chooses to use the input feature to express a level of interest in the product, kiosk 18 may ask customer 4 whether customer 4 would like to enter his or her name. If customer 4 chooses to enter his or her name, kiosk 18 may instruct business logic server 24 to associate the name of the customer with the set of customer preference information already provided by customer 4 as answers to the questions during this kiosk session. In addition, if customer 4 enters his or her name, kiosk 18 may ask customer 4 whether customer 4 would be interested in discussing the after-market products with a sales representative. If customer 4 is interested in discussing the after-market products with a sales representative, kiosk 18 may enable manager 16 to see which levels of interest customer 4 has expressed in various after-market products. After determining whether customer 4 is interested in discussing the after-market products with a sales representative, or after customer 4 refuses to enter a name or after customer 4 expresses a lack of interest in discussing the products with a sales representative, kiosk 18 may again display the menu screen. Customer 4 may then continue viewing descriptions of after-market products and inputting levels of interest in the products.

Customer 4 may eventually finish interacting with kiosk 18. At this point, customer 4 may end a session with kiosk 18 by selecting a “finished” button presented by the kiosk or by simply walking away. For example, kiosk 18 may determine that customer 4 has finished a session with the kiosk when the kiosk has received no input from the customer within a given time. When customer 4 finishes a session with kiosk 18, kiosk 18 may send any additional customer preference information to business logic server 24. For example, kiosk 18 may send to business logic server 24 any levels of interest expressed by customer 4 in the various after-market motor vehicle products expressed by customer 4. In another example, kiosk 18 may measure how much time customer 4 spent looking at each of the products presented by kiosk 18. How much time customer 4 spent looking at a product may be an indirect measure of the customer's level of interest in the product. Upon receiving this additional customer preference information, business logic server 24 may associate the additional customer preference information with the set of customer preference information that customer 4 already provided. Business logic server 24 may then use the set of customer preference information to identify a set of after-market motor vehicle products in which customer 4 may be interested.

After customer 4 finishes interacting with kiosk 18, the sales finalization phase of the sales process may begin. If customer 4 entered a name and expressed an interest in discussing the after-market products with a sales representative, business logic server 24 may alert manager 16 that customer 4 has finished his or her session with kiosk 18. For example, business logic server 24 may send an alert to an F&I manager console 26 in F&I office 12. F&I manager console 26 may be a personal computer, a laptop computer, a handheld or tablet computer, a mobile telephone, a thin-client computer, a computer workstation, or otherwise. For instance, F&I manager console 26 may be the general purpose personal computer on which manager 16 performs most of his or her daily work. When manager 16 receives the alert, manager 16 may use F&I manager console 26 to view the set of after-market products that business logic server 24 has identified for customer 4. Manager 16 may then edit the set to add or remove products, to set prices for products and packages, and so on. Manager 16 may make decisions on how to edit the set of products based on the customer preference information that sales representative 14 provided to manager 16 at an earlier phase of the sales process. After manager 16 finishes editing the packages, manager 16 may invite customer 4 into F&I office 12 to finalize the sale of the motor vehicle.

When customer 4 enters F&I office 12, manager 16 may introduce himself or herself to customer 4 and begin to build rapport with customer 4. After such introductory exchanges, manager 16 may direct the attention of customer 4 to an F&I customer console 28. F&I customer console 28 may be a personal computer, a laptop computer, a handheld or tablet computer, a thin-client computer, a computer workstation, or otherwise. Furthermore, F&I customer console 28 may include a touch-sensitive monitor to receive input from customer 4. When manager 16 directs the attention of customer 4 to F&I customer console 28, manager 16 may cause F&I customer console 28 to display a view that describes packages of after-market products as edited by manager 16.

F&I customer console 28 may display these packages with a look-and-feel that customer 4 would recognize as being similar to the look-and-feel used in kiosk 18. The fact that F&I customer console 28 uses the same look-and-feel as kiosk 18 may serve as a cue to customer 4 that kiosk 18 and F&I customer console 28 are related systems. Consequently, customer 4 may be familiar with the look-and-feel and experience less surprise when F&I customer console 28 presents customized packages of products.

Manager 16 may then discuss with customer 4 each of the packages of after-market products with the goal of convincing customer 4 to purchase one of the packages. F&I customer console 28 may receive input from customer 4 to view more information, to add or to remove products from a package, and so on. Because customer 4 has already used kiosk 18 to read about the after-market products and to select products of interest, the after-market products are less likely to surprise customer 4. As a result, customer 4 may experience less sales pressure from manager 16, and, consequently may have a more enjoyable sales experience.

F&I customer console 28 may receive customer purchase information from customer 4. Customer purchase information is information that indicates a decision of customer 4 whether to purchase any of the packages of after-market products. When F&I customer console 28 receives such input, F&I customer console 28 sends the customer purchase information to business logic server 24. Business logic server 24 may use the information regarding the purchasing decision to refine the business rules that business logic server 24 uses to identify after-market products that might interest subsequent customers. For example, if business logic server 24 previously added ten to the score associated with a stain-resistant coating when customer 4 is purchasing a minivan and has children, but customer 4 does not purchase the stain-resistant coating, then business logic server 24 may, in the future, add only nine to the score associated with the stain-resistant coating.

In addition, after business logic server 24 receives the customer purchase information for customer 4, business logic server 24 may remove from preference database 25 any information that personally identifies customer 4. For example, business logic server 24 may delete the name that customer 4 provided to kiosk 18. In this way, system 2 eliminates information that may personally identify a source of customer preference information. Because the data cannot be associated with an individual customer, dealership 6A or a provider of system 2 may sell or reuse the collected customer preference information.

In addition to sending the information regarding the purchase decisions to business logic server 24, F&I customer console 28 may send the information to an F&I source server 30. F&I source server 30 may be one of dealership support servers 5 and may be an HTTP server that calculates prices and financing for the selected after-market products and motor vehicle. In addition, F&I source server 30 maintains records of purchasing decisions in a user database 32. Manager 16 may use the records maintained by F&I source server 30 to record information such as personal data about customer 4 (e.g., address, phone number, employment, etc.), purchasing details, insurance details, financing details, and so on. Employees of dealership 6A may use the information stored by F&I source server 30 for a wide variety of purposes. Such purposes may include customer-relation management, maintenance scheduling, compliance with record-keeping regulations, and so on.

After customer 4 makes a purchasing decision on the after-market products presented on F&I customer console 28, customer 4 and manager 16 may finalize other details of the sale of the motor vehicle. Such details may include signing of title documents, signing of warranty and finance agreements, and so on. When customer 4 and manager 16 finish finalizing the details of the sale, dealership 6A may install the purchased after-market products and customer 4 may take possession of the motor vehicle. At this point, the sales finalization phase of the sales process may be complete.

As illustrated in the example of FIG. 2, public area 10 may include digital signage units 34A through 34N (collectively, “digital signage units 34”). Each of digital signage units 34 may be a device that presents video and may optionally present audio. For example, each of digital signage units 34 may be a flat panel plasma, a liquid crystal display, or a cathode ray tube television. Digital signage units 34 may be configured to receive input directly or indirectly from a signage content server 36. Signage content server 36 may be one of dealership support servers 5 and may be a rackmount server platform that generates the audio/video content that digital signage units 34 present.

Business logic server 24 may use customer preference information collected from dealership 6A and other dealerships to select presentation frequencies at which advertisements for after-market motor vehicle automotive products are presented on digital signage units 34. Business logic server 24 may then instruct signage content server 36 to present the advertisements for the after-market motor vehicle products according to the presentation frequencies selected for the advertisements on digital signage units 34. For example, business logic server 24 may select a presentation frequency for a first after-market product and a presentation frequency for a second after-market product such that the advertisement for the first after-market product is presented twice as frequently as the advertisement for the second after-market product. In this way, business logic server 24 uses preference information collected from customers to select advertisements for after-market products that may have particular appeal to customers of dealership 6A. The advertisements may encourage customers to use kiosk 18 to learn more about the advertised after-market motor vehicle products.

System 2 may provide one or more advantages. For example, system 2 may familiarize customers with after-market motor vehicle products during a sales process. Because customers may read about the after-market products without any sales pressure, the customers may be more comfortable when they are asked to decide whether to purchase the after-market products. Because the customers may be more comfortable, the customers may be more inclined to buy the after-market products. In another example, system 2 may help managers identify packages of after-market products that are suited to the interests of individual customers. This may further increase the likelihood that the customers will purchase after-market products.

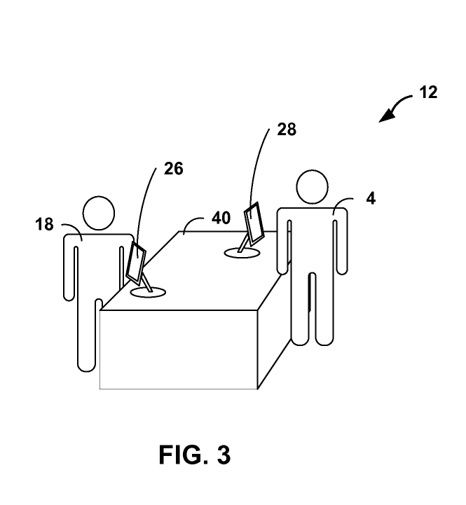

FIG. 3 is a diagram illustrating an exemplary environment for F&I office 12 of dealership 6A. During a sale finalization phase of the sales process, manager 18 may invite customer 4 into F&I office 12 to finalize the sale of the motor vehicle. After customer 4 enters F&I office 12, manager 18 and customer 4 may sit across a desk 40 from one another. Manager 18 may be able to see F&I manager console 26 and customer 4 may be able to see F&I customer console 28. F&I manager console 26 and F&I customer console 28 may sit on desk 40.

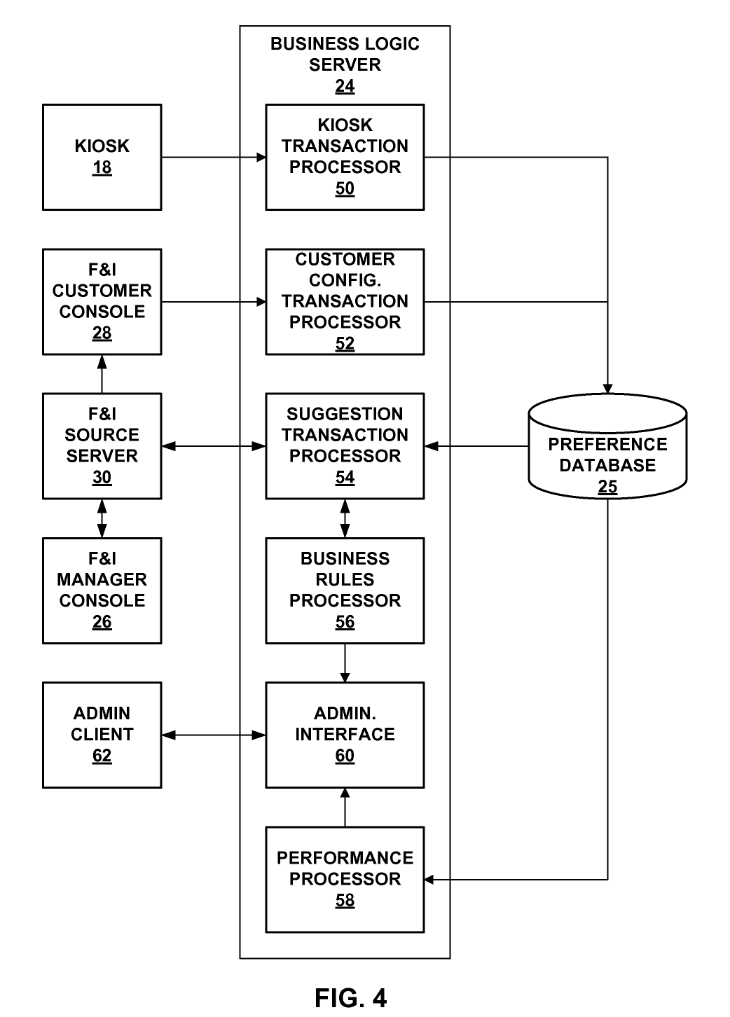

FIG. 4 is a block diagram illustrating an exemplary business logic server 24 to identify sets of after-market motor vehicle products for customers. As illustrated in the example of FIG. 4, business logic server 24 may include a set of components. Each of these components may be implemented in hardware or in software. If the components are implemented in software, the instructions of the software may be stored in a computer-readable medium (e.g., a compact disc, a hard disk, a floppy disk, a random access memory unit, etc.).

When customer 4 starts a session with kiosk 18, kiosk 18 may create a session identifier that uniquely identifies the session. Subsequently, when customer 4 answers the customer preference questions presented by kiosk 18, kiosk 18 may send the customer preference information along with the session identifier to a kiosk transaction processor 50 in business logic server 24. When kiosk transaction processor 50 receives the customer preference information and the session identifier, kiosk transaction processor 50 may create records in customer preference database 25 to store the customer preference information. Each of these records may be identified and accessed using the session identifier.

When customer 4 enters a name into kiosk 18, kiosk 18 stores the name with the set of customer preference information for the current kiosk session. At the end of a kiosk session, kiosk 18 may send the name, any additional customer preference information, and the session identifier to business logic server 24. Kiosk transaction processor 50 may use the session identifier to associate the name with the set of customer preference information in customer preference database 25 associated with the session identifier and add the additional customer preference information to the set of customer preference information associated with the session identifier.

Because some customers may be uncomfortable with the idea of entering a name into kiosk 18, if customer 4 chooses not to enter a name, kiosk 18 may prompt customer 4 whether customer 4 would like a paper copy of the customer preference information generated during the kiosk session. If customer 4 wants a paper copy of the customer preference information, kiosk 18 may print a paper copy of the customer preference information generated by customer 4 during the kiosk session. Subsequently, customer 4 may give the paper copy to sales associate 14 or manager 16.

After customer 4 completes a session with kiosk 18, manager 16 may use F&I manager console 26 to send a request to a suggestion transaction processor 54 in business logic server 24 for a set of recent sessions at kiosk 18 during which a customer provided a name and asked for assistance with the products. In response to the request, suggestion transaction processor 54 may send a set of names associated with such sessions along with the session identifier of these sessions. When F&I manager console 26 receives the set of recent sessions at kiosk 18, manager 16 may select a session associated with customer from the set. Manager 16 may then submit purchase information and additional customer preference information to F&I source server 30 along with the session identifier of the selected session. Manager 16 may also use F&I manager console 26 to enter customer preference information included in a paper-copy provided by customer 4 to identify packages of after-market motor vehicle products that might interest customer 4. When F&I source server 30 receives the purchase information, additional customer preference information, and session identifier, F&I source server 30 may forward the purchase information, additional customer preference information, and session identifier to suggestion transaction processor 54. Once suggestion transaction processor 54 receives this information, suggestion transaction processor 54 may use the session identifier to add the additional customer preference information to customer preference database 25. Next, suggestion transaction processor 54 may provide all of the customer preference information for the session identified by the session identifier to a business rules processor 56 in business logic server 24.

Business rules processor 56 may apply a set of business rules to the customer preference information provided by suggestion transaction processor 54. As described above, business rules processor 56 may apply the rules to customer preference information in order to obtain a set of scores for each available after-market motor vehicle product. Business rules processor 56 may then identify which ones of the after-market motor vehicle products have the highest scores. These scores may represent an approximation of the likelihood that customer 4 would be interested in purchasing the respective after-market products. In addition, business rules processor 56 may identify packages of after-market products in which customer 4 is likely to be interested. After business rules processor 56 identifies products or packages of products in which customer 4 is likely to be interested, business rules processor 56 may send to suggestion transaction processor 54 a set of products or packages of products business rules processor 56 has identified as likely to interest customer 4.

When suggestion transaction processor 54 receives the set of identified products or packages from business rules processor 56, suggestion transaction processor 54 may forward the set along with the session identifier to F&I source server 30. Upon receiving the set, F&I source server 30 may calculate current price and financing information for the products or packages in the set. F&I source server 30 may then forward the set and session identifier to F&I manager console 26 along with the calculated price and financing information. After F&I manager console 26 receives the set of identified products or packages from F&I source server 30, manager 16 may use F&I manager console 26 to review and edit the set. Manager 16 may then submit the edited set and session identifier to F&I source server 30. Next, F&I source server 30 may forward the edited set, price and financing information, and session identifier to F&I customer console 28.

F&I customer console 28 may display the edited set of after-market products and packages along with the price and financing information. Customer 4 may interact with F&I customer console 28 to make purchasing decisions regarding the after-market products and packages. F&I customer console 28 may send customer purchase information and the session identifier to F&I source server 30. F&I source server 30 may then strip personally identifiable information from the customer purchase information and forward the customer purchase information and session identifier to a customer configuration transaction processor 52 in business logic server 24. Because F&I customer console 28 sends the session identifier to customer configuration transaction processor 52, customer configuration transaction processor 52 may associate the completed purchase information with the customer preference information of the session.

Business logic server 24 may also include a performance processor 58 to analyze customer preference database 25 and to generate performance analytics and statistics reports. For example, performance processor 58 may analyze customer preference database 25 to determine how frequently a customer actually purchases an identified after-market motor vehicle product.

After performance processor 58 generates a performance analytics and statistics report, performance processor 58 may provide the report to an administrative interface 60 in business logic server 24. Administrative interface 60 may be a graphical or command line user interface that presents reports generated by performance processor 58. An administrator (not shown) using an administrative client device 62 may access administrative interface 60 to view the reports. Furthermore, the administrator may use administrative interface 60 to edit manually the business rules that business rules processor 56 uses to identify after-market motor vehicle products and packages.

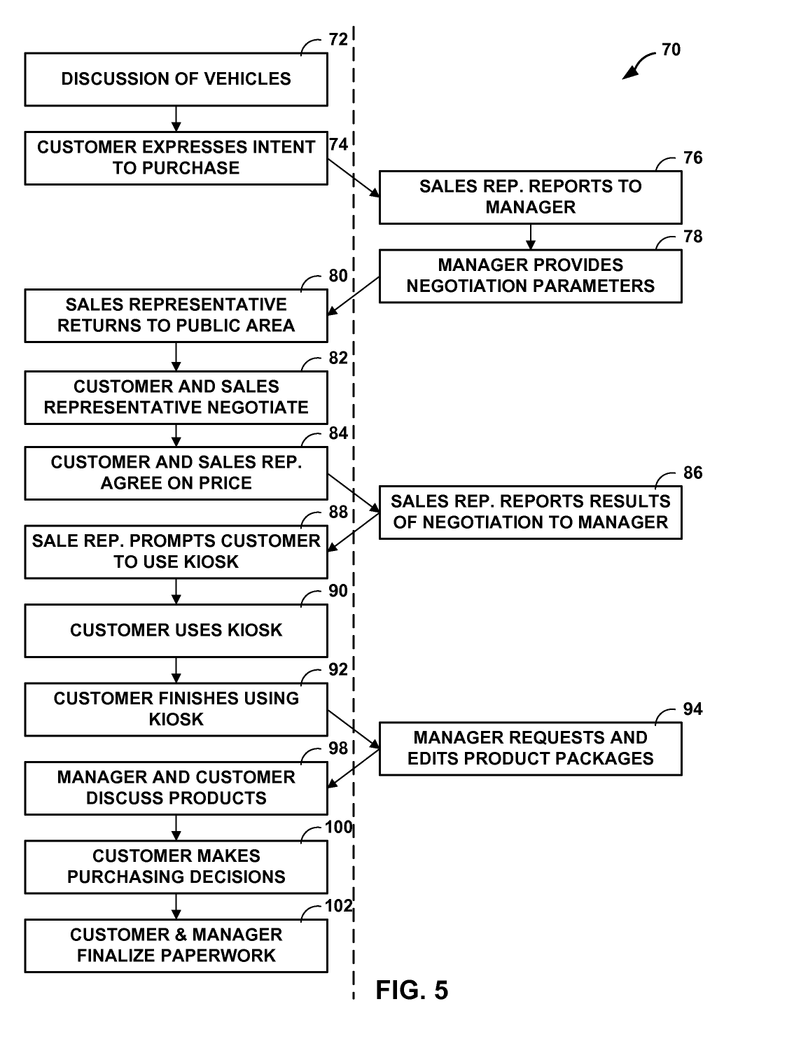

FIG. 5 is a flowchart illustrating an exemplary sales process 70. In the example of FIG. 5, steps of sales process 70 conducted in the presence of customer 4 are illustrated on the left of FIG. 5 and steps of sales process 70 conducted outside the presence of customer 4 are illustrated on the right of FIG. 5.

Initially, customer 4 and sales representative 14 may discuss motor vehicles, perform test drives, and so on (72). Eventually, customer 4 may express intent to purchase a motor vehicle from dealership 6A (74).

After customer 4 expresses intent to purchase a motor vehicle from dealership 6A, sales representative 14 may report the customer's intent to purchase the motor vehicle from dealership 6A to manager 16 (76). Manager 16 may then provide negotiation parameters to sales representative 14 (78).

When sales representative 14 receives the negotiation parameters from manager 16, sales representative 14 may return to public area 10 and customer 4 (80). Customer 4 and sales representative 14 may then negotiate a price for the motor vehicle (82). During negotiations, sales representative 14 may return to manager 16 one or more times to obtain new negotiation parameters if customer 4 insists on a price that is lower than the lowest authorized price. At the end of negotiation phase, customer 4 and sales representative 14 may agree on a price for the motor vehicle (84).

After customer 4 and sales representative 14 agree on a price for the motor vehicle, sales representative 14 may report results of the negotiation to manager 16 (86). Next, sales representative 14 returns to customer 4, and may prompt or encourage customer 4 to use kiosk 18 to learn about after-market motor vehicle products (88). Customer 4 may then use kiosk 18 to learn about after-market products (90). Eventually, customer 4 ends the session with kiosk 18 (92). After customer 4 ends the session with kiosk 18, manager 16 may use F&I manager console 26 to review and edit product packages for customer 4 (94).

Next, manager 16 invites customer 4 into F&I office 12 and may then discuss after-market products and finance and insurance details (98). In addition, customer 4 may use F&I customer console 28 to make purchasing decisions regarding after-market motor vehicle products (100). The sales finalization phase may end when customer 4 makes a purchasing decision regarding the after-market motor vehicle products and completes any finance and insurance paperwork (102).

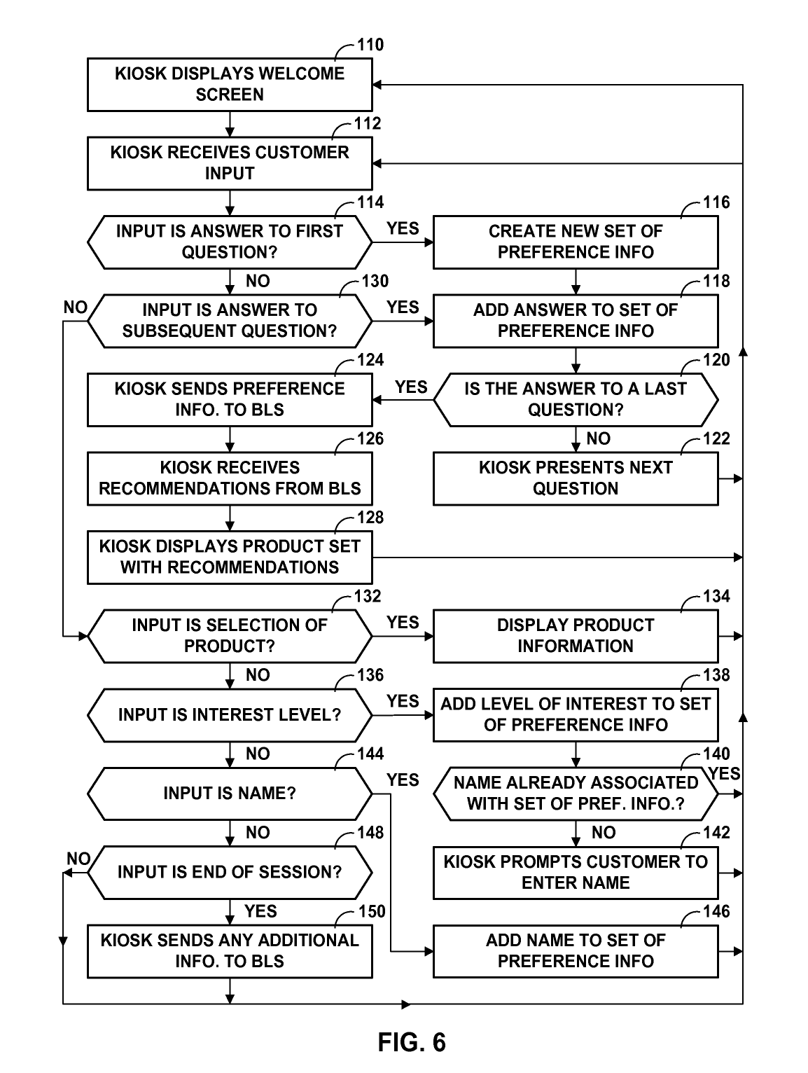

FIG. 6 is a flowchart illustrating an exemplary operation of kiosk 18. Initially, kiosk 18 presents a welcome screen (110). Next, kiosk 18 may receive input from customer 4 (112). Kiosk 18 may perform different operations depending on the type of the input.

If the input is an answer to a first question (“YES” of 114), kiosk 18 may create a new set of customer preference information for a new current kiosk session (116). When kiosk 18 creates a new set of customer preference information, kiosk 18 may create a unique session identifier for the set of customer preference information. Kiosk 18 may then add the answer to the first question to the set of customer preference information (118). After adding the answer to the set of customer preference information, kiosk 18 may determine whether the question is a last question (120). If the question is not a last question (“NO” of 120), kiosk 18 presents a view that presents a next question (122). Kiosk 18 may then loop back and receive user input (112). On the other hand, if the question is a last question (“YES” of 120), kiosk 18 sends the set of customer preference information to business logic server 24 (124). Subsequently, kiosk 18 may receive information that identifies a recommended set of after-market motor vehicle products in which customer 4 may be interested (126). After receiving this information, kiosk 18 may present a menu view that includes the identified recommended set of after-market motor vehicle products (128). When kiosk 18 presents the menu view, kiosk 18 may loop back and receive input from customer 4 (112).

If the input is not an answer to a first question (“NO” of 114), but is an answer to a subsequent question (“YES” of 130), kiosk 18 adds the answer to the set of customer preference information (118). Kiosk 18 then determines whether the question is a last question (120). If the question is not a last question (“NO” of 120), kiosk 18 presents a view that presents a next question (122). Kiosk 18 may then loop back and receive user input (112). On the other hand, if the question is a last question (“YES” of 120), kiosk 18 sends the set of customer preference information to business logic server 24 (124). Subsequently, kiosk 18 may receive information that identifies a recommended set of after-market motor vehicle products in which customer 4 may be interested (126). After receiving this information, kiosk 18 may present a menu view that includes the identified recommended set of after-market motor vehicle products (128). When kiosk 18 presents the menu view, kiosk 18 may loop back and receive input from customer 4 (112).

If the input is not an answer to a subsequent question (“NO” of 130), but is a selection of one of the after-market motor vehicle products from the menu view (“YES” of 132), kiosk 18 presents a view that displays information about the selected after-market motor vehicle product (134). When kiosk 18 presents the view that displays information about the selected after-market product, kiosk 18 may loop back and receive input from customer 4 (112).

If the input is not a selection of one of the after-market motor vehicle products from the menu view (“NO” of 132), but is an expression of a level of interest in a product by customer 4 (“YES” of 136), kiosk 18 may add the level of interest to the set of customer preference information (138). Next, kiosk 18 may determine whether a name is associated with the set of customer preference information for the current kiosk session (140). If a name is already associated with the set of customer preference information (“YES” of 140), kiosk 18 may loop back to receive input from customer 4 (112). However, if a name is not yet associated with the customer preference information (“NO” of 140), kiosk 18 prompts customer 4 to enter a name to associate with the set of customer preference information (142). After kiosk 18 prompts customer 4 to enter a name, kiosk 18 may loop back to receive input from customer 4 (112).

If the input is a name (“YES” of 144), kiosk 18 adds the name to the set of customer preference information for the current kiosk session (146). At the end of the current kiosk session, business logic server 24 may receive the name along with any additional customer preference information. After adding the name to the set of customer preference information, kiosk 18 may loop back to receive input from customer 4 (112).

If the input is an instruction to end the current kiosk session (“YES” of 148), kiosk 18 may send any additional customer preference information to business logic server 24 (150). This additional customer preference information may include a name to be associated with the set of customer preference information. Kiosk 18 may then end the current kiosk session and display the welcome screen again (110). If the input is not an instruction to end the current kiosk session (“NO” of 148), kiosk 18 may loop back to receive input from customer 4 (112).

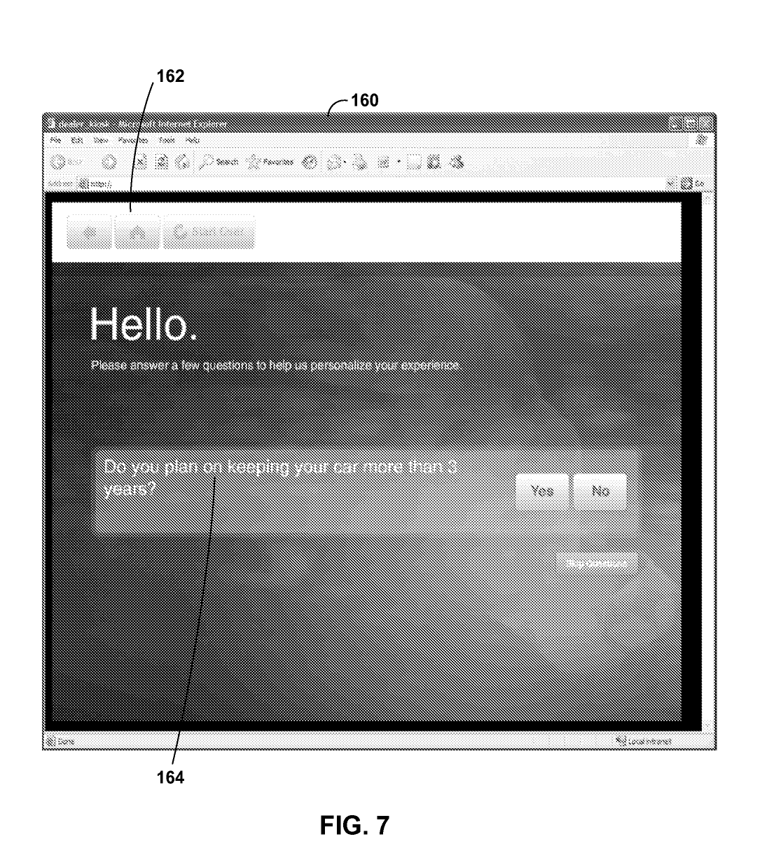

FIG. 7 is a screenshot illustrating an exemplary welcome screen 160 presented by kiosk 18. Welcome screen 160 includes a set of navigation buttons 162. The left-most one of navigation buttons 162 is a “go back” button. When customer 4 selects the “go back” button, kiosk 18 changes the current view to a previous view. The middle one of navigation buttons 162 is a home button. When customer 4 selects the home button, kiosk 18 changes the current view to a home view. The home view may be welcome screen 160, a menu view that presents a set of after-market motor vehicle products, or otherwise. The right-most one of navigation buttons 162 is a “start-over button.” When customer 4 selects the “start-over” button, kiosk 18 starts a new kiosk sessions and presents welcome screen 160.

In addition, welcome screen 160 includes a question 164 that may elicit customer preference information. As illustrated in the example of FIG. 7, question 164 asks “Do you plan on keeping your car for more than 3 years?” Question 164 is accompanied by a “Yes” button and a “No” button. When customer 4 selects either the “Yes” button or the “No” button of question 164, kiosk 18 may retain the answer as customer preference information and display a next view.

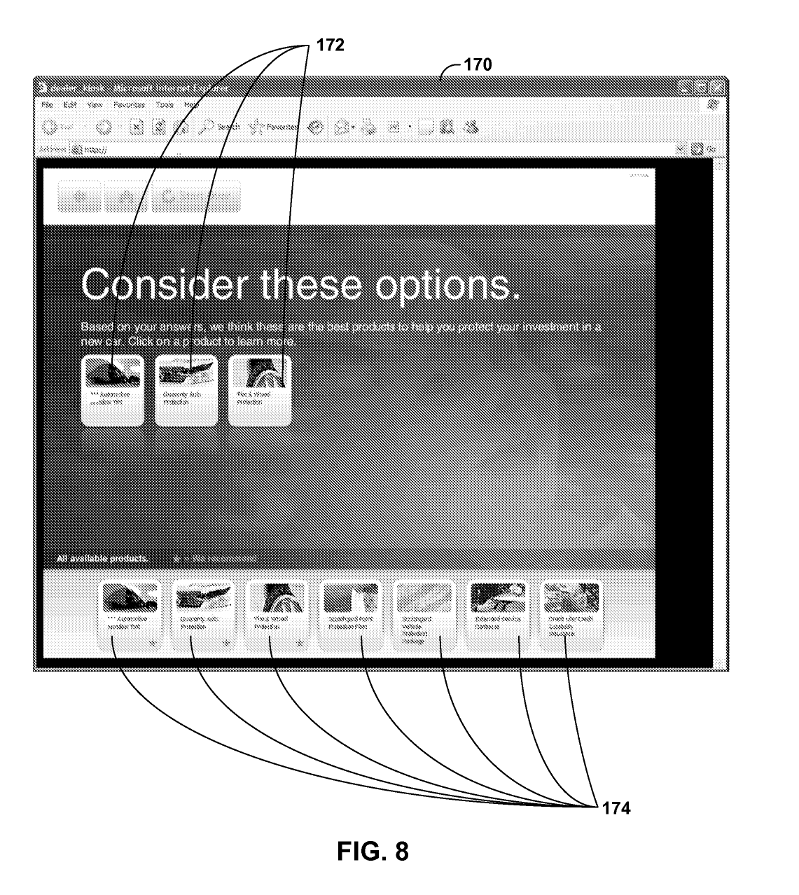

FIG. 8 is a screenshot illustrating an exemplary after-market motor vehicle product menu view 170 presented by kiosk 18. Product menu view 170 may include a set of reference buttons that are equivalent to reference buttons 162 in welcome screen 160.

Product menu view 170 includes text that invites customer 4 to “Consider these options.” Beneath this text, product menu view 170 displays a set of “recommended” products 172 that business logic server 24 has identified as after-market motor vehicle products that customer 4 may be interested in purchasing with a motor vehicle. In the example illustrated in FIG. 8, the set of “recommended” products 152 includes “Automotive Window Tint”, “Guarantee Auto Protection”, and “Tire & Wheel Protection.”

Product menu view 170 also includes a set of available after-market motor vehicle products 174. Set of products 174 includes both “recommended” and non-recommended products. As illustrated in the example of FIG. 8, “recommended” products in set of products 174 may be specially denoted. In this example, stars denote “recommended” products.

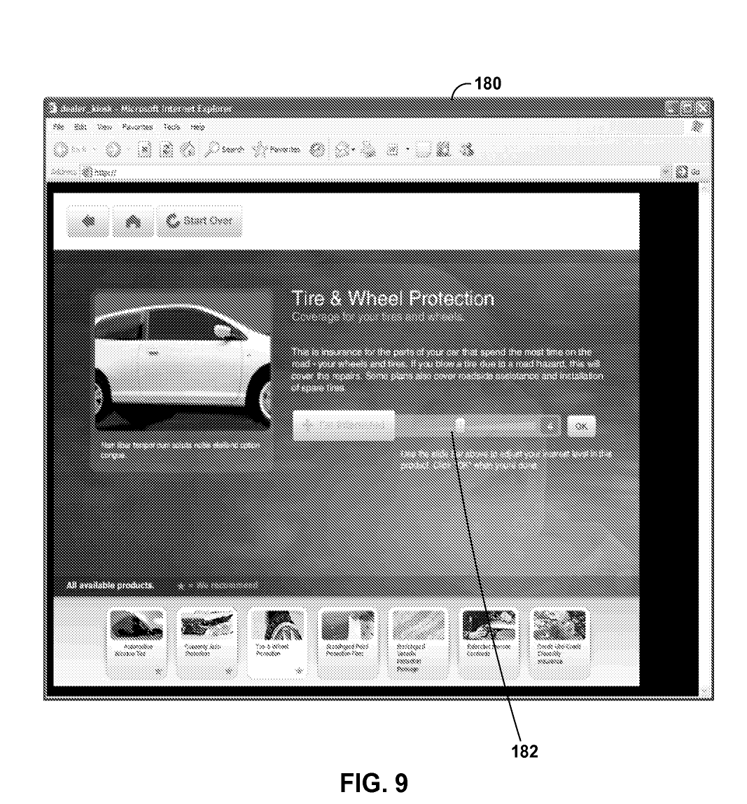

FIG. 9 is a screenshot illustrating an exemplary product detail view 180 presented by kiosk 18. In the example of FIG. 9, product detail view 180 provides additional information about “Tire & Wheel Protection.” In this example, product detail view 180 explains that “Tire & Wheel Protection ”is insurance for the parts of your car that spend the most time on the road—your wheels and tires. If you blow a tire due to a road hazard, this will cover your repairs. Some plans also cover roadside assistance and installation of spare tires.“

Product detail view 180 also includes an input element 182 through which customer 4 may optionally express his or her level of interest in “Tire & Wheel Protection.” As illustrated in product detail view 180, input element 182 is a slide bar. To use input element 182, customer 4 may drag a cursor along a horizontal bar. Customer 4 may indicate increasingly higher levels of interest by dragging the cursor further to the right. When customer 4 has positioned the cursor at a position that appropriately reflects the customer's level of interest in this product, the customer may select the “OK” button located to the right of input element 182. When customer 4 selects the “OK” button, kiosk 18 may store the position of input element 182 as customer preference information. If customer 4 has not already provided a name to be associated with the set of customer preference information of the current kiosk session, kiosk 18 may prompt customer 4 to enter a name to be associated with the set of customer preference data.

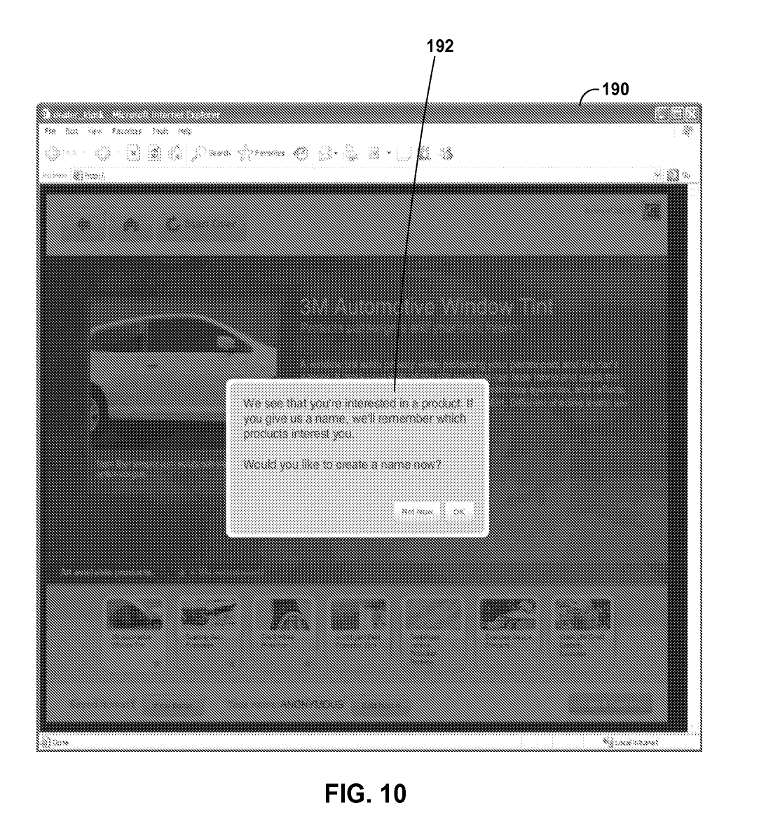

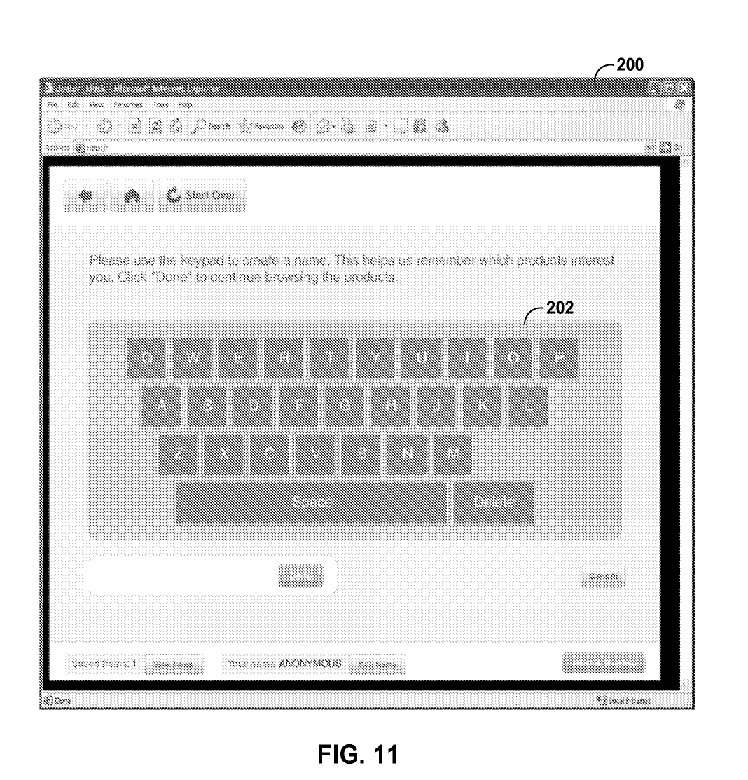

FIG. 10 is a screenshot illustrating an exemplary view 190 that prompts customer 4 to decide whether to associate a name with the customer preference information of a current kiosk session. In the example of FIG. 10, view 190 includes a pop-up window 192. Window 192 includes the text, “We see that you are interested in a product. If you give us your name, we'll remember which products interest you. Would you like to create a name now?” Window 192 also includes a “Yes” button and a “No” button. If customer 4 selects the “Yes” button, kiosk 18 may present a view of that shows a keyboard 202 (FIG. 11) by which customer 4 may enter a name for customer preference information of the current kiosk session. If customer 4 selects the “No” button, kiosk 18 may present a product detail view, product recommendation view 170, or another view.

Because some customers may be uncomfortable with the idea of entering a name into kiosk 18, if customer 4 chooses not to enter a name, kiosk 18 may prompt customer 4 to decide whether customer 4 would like a paper copy of the customer preference information generated during the kiosk session. If customer 4 wants a paper copy of the customer preference information, kiosk 18 may print a paper copy of the customer preference information generated by customer 4 during the kiosk session. Subsequently, customer 4 may give the paper copy to sales associate 14 or manager 16. Manager 16 may be able to use the paper-copy to identify packages of after-market motor vehicle products that might interest customer 4. For example, manager 16 may enter the customer preference information into F&I management console 26 and receive automatically identified sets of after-market products from business logic server 24. In another example, manager 16 may manually identify sets of after-market motor vehicle products for customer 4.

FIG. 11 is a screenshot illustrating an exemplary view 200 presented by kiosk 18 that shows a keyboard 202. Customer 4 may select letters in keyboard 202 to enter a name to associate with the set of customer preference information of a current kiosk session.

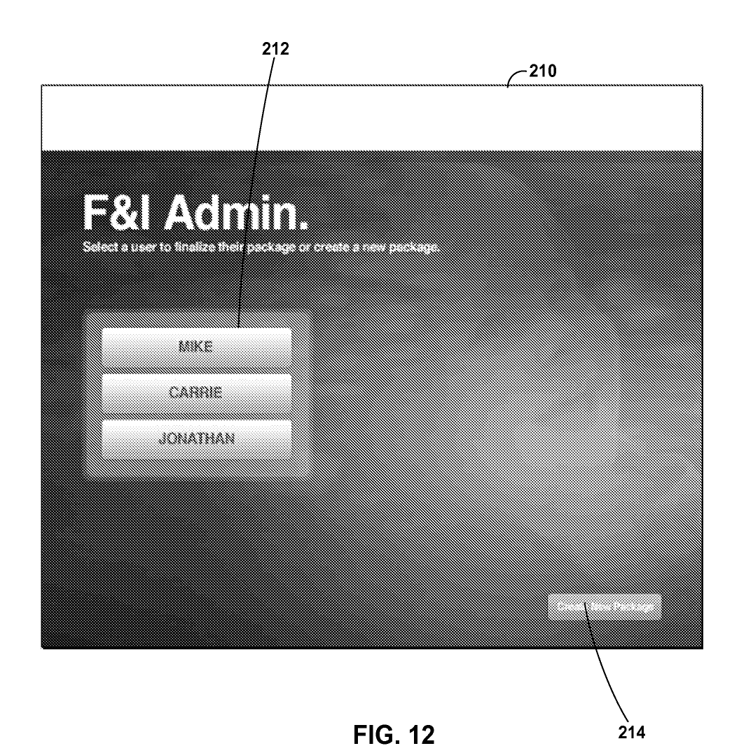

FIG. 12 is a screenshot illustrating an exemplary session selection view 210 presented by F&I manager console 26. As discussed above, prior to inviting customer 4 into F&I office 12, manager 16 may review and edit packages of after-market motor vehicle products identified by business logic server 24. To review and edit packages, manager 16 may use F&I manager console 26 to send a request to business logic server 24 for a set of names associated with sets of customer preference information of recent kiosk sessions on kiosk 18. When F&I manager console 26 receives the set from business logic server 24, F&I manager console 26 may present session selection view 210.

Session selection view 210 includes a set of names 212. In the example of FIG. 12, set 212 includes the names “Mike,” “Carrie,” and “Jonathan.” To review and edit packages of after-market motor vehicle products for one of these customers, manager 16 may select one of the names presented in set 212.

If manager 16 wishes to review and edit a package of after-market products for a customer whose name is not on set 212, manager 16 may select a button 214 labeled “Create New Package.” When manager 16 selects button 214, F&I manager console 26 may present a view through which manager 16 may manually create one or more packages of after-market motor vehicle products for the customer. In manually creating packages for a customer, manager 16 may use customer preference information divulged to manager 16 by sales representative 14. Furthermore, when manager 16 chooses to manually create packages of after-market products for a customer, business logic server 24 may provide a set of default packages to F&I manager console 26. Business logic server 24 may select products in the default packages based on average customer preference information for dealership 6A. Manager 16 may then use F&I manager console 26 to edit the default packages in light of what customer preference information manager 16 has about customer 4. Alternatively, manager 16 may review and edit a package of after-market motor vehicle products based on a paper copy of customer preference information provided by customer 4.

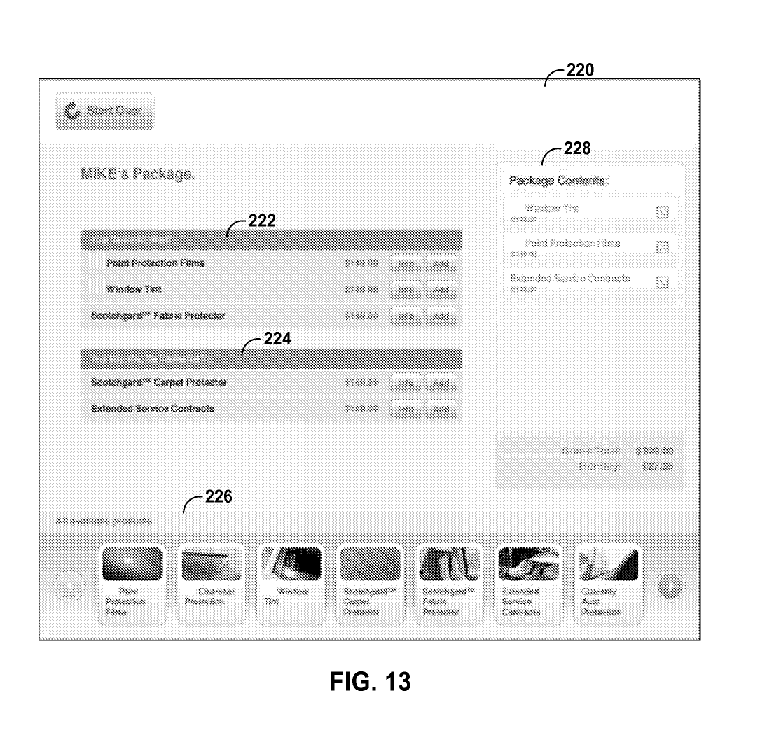

FIG. 13 is a screenshot illustrating an exemplary product package view 220 presented by F&I customer console 28. Product package view 220 includes a set of “selected” (i.e., recommended) items 222, a set of additional items 224, and a set of all available items 226. Items in set of “recommended” items 222 may be after-market motor vehicle products that business logic server 24 has identified for customer 4. Items in set of additional items 224 may be after-market motor vehicle products that may be suited for use with products in set 222. Set 226 includes available after-market motor vehicle products. In addition, product package view 220 includes a set 228 of products that customer 4 has decided to purchase with the motor vehicle.

Various embodiments of the invention have been described. These and other embodiments are within the scope of the following claims.

1. A method comprising:
collecting, from a customer during a sales process for a motor vehicle, a set of customer preference information regarding after-market motor vehicle products using a kiosk installed in a motor vehicle dealership;
processing the collected set of customer preference information with a server to automatically identify a set of after-market motor vehicle products that the customer is likely to be interested in purchasing along with the motor vehicle;
displaying, with a customer console, the identified set of after-market motor vehicle products; and
collecting, with the customer console, customer purchase information that describes which after-market motor vehicle products the customer chose to purchase along with the motor vehicle.

2. The method of claim 1, wherein collecting a set of customer preference information comprises:
presenting, with the kiosk, views that ask a set of questions; and
receiving answers to the questions from the customer.

3. The method of claim 2, wherein receiving answers comprises receiving input from a touch-screen monitor.

4. The method of claim 1, wherein collecting a set of customer preference information comprises:
collecting, from the customer, a first set of customer preference information using the kiosk;
using the first set of collected customer preference information to automatically identify a recommended set of after-market motor vehicle products that the customer is likely to be interested in purchasing along with the motor vehicle;
presenting the identified recommended set of after-market motor vehicle products using the kiosk;
collecting, from the customer, additional customer preference information regarding the after-market motor vehicle products in the identified set of after-market motor vehicle products using the kiosk; and
wherein using the collected set of customer preference information to identify a set of after-market motor vehicle products comprises using the first set of customer preference information from the customer and the additional customer preference information from the customer to identify the set of after-market motor vehicle products.

5. The method of claim 1, wherein collecting the set of customer preference information comprises:
prompting the customer to input a level of interest in an after-market motor vehicle product; and
receiving the level of interest in the after-market motor vehicle product from the customer.

6. The method of claim 1, wherein the method further comprises editing the identified set of after-market motor vehicle products prior to displaying the set of after-market motor vehicle products using the customer console.

7. The method of claim 6,
wherein collecting a set of customer preference information comprises prompting the customer to input a name to be associated with the set of customer preference information collected from the customer; and
wherein the method further comprises:
presenting a set of names associated with sets of customer preference information collected using the kiosk; and
receiving input that selects from the set of names a name associated with one of the sets of customer preference information; and
wherein editing the identified set of after-market motor vehicle products comprises editing the selected one of the sets of customer preference information.

8. The method of claim 1, wherein the method further comprises communicating the set of customer preference information from the kiosk to the server located remote from the motor vehicle dealership.

9. The method of claim 1, wherein processing the collected set of customer preference information comprises applying a set of business rules to the set of customer preference information to identify the set of after-market motor vehicle products.

10. The method of claim 9, wherein applying a set of business rules comprises applying a set of condition-action rules.

11. The method of claim 9, wherein applying a set of business rules comprises:
calculating a score for available after-market motor vehicle products; and
identifying the after-market motor vehicle products with scores that indicate that the customer is likely to be interested in purchasing the after-market motor vehicle products.

12. The method of claim 1, wherein using the collected set of customer preference information comprises using the collected set of customer preference information from the customer and a set of customer preference information from another customer to identify the set of after-market motor vehicle products that the customer is likely to be interested in purchasing along with the motor vehicle.

13. The method of claim 1, wherein using the collected set of customer preference information comprises automatically identifying a package of after-market motor vehicle products that is sellable as a unit.

14. The method of claim 13, wherein displaying the identified set of after-market motor vehicle products comprises displaying the identified package of after-market motor vehicle products.

15. The method of claim 1, wherein the method further comprises encouraging the customer to use the kiosk after agreeing to a price for the motor vehicle.

16. The method of claim 1, wherein the method further comprises displaying information that describes the after-market motor vehicle products using the kiosk.

17. The method of claim 1, wherein collecting customer purchase information comprises automatically using the customer purchase information to refine which after-market motor vehicle products are identified given the collected set of customer preference information.

18. The method of claim 1, wherein the method further comprises:
using the collected set of customer preference information to select presentation frequencies for advertisements for after-market motor vehicle products; and
presenting the advertisements for the after-market motor vehicle products according to the presentation frequencies selected for the advertisements in the motor vehicle dealership.

19. The method of claim 18, wherein using the collected set of customer preference information to select presentation frequencies comprises using the collected set of customer preference information from the customer and collected sets of customer preference information from other customers to select the presentation frequencies.

20. The method of claim 1, wherein the after-market motor vehicle products include physical and intangible after-market motor vehicle products.

21. A system comprising:
a computer kiosk to collect from a customer a set of customer preference information regarding after-market motor vehicle products during a sales process for a motor vehicle, wherein the computer kiosk is installed in a motor vehicle dealership;
a business logic server to use the collected set of customer preference information to automatically identify a set of after-market motor vehicle products that the customer is likely to be interested in purchasing along with the motor vehicle;
a customer console to display the identified set of after-market motor vehicle products and to collect customer purchase information that describes which after-market motor vehicle products the customer chose to purchase along with the motor vehicle; and
a computer network to facilitate communication among the kiosk, the business logic server, and the customer console.

22. The system of claim 21, wherein the kiosk collects a set of customer preference information by presenting view that ask a set of questions and receiving answers to the questions from the customer.

23. The system of claim 21,
wherein the kiosk collects a first set of customer preference information;
wherein the business logic server uses the first set of customer preference information to identify a recommended set of after-market motor vehicle products that the customer is likely to be interested in purchasing along with the motor vehicle;
wherein the kiosk presents the identified recommended set of after-market motor vehicle products;
wherein the kiosk collects additional customer preference information regarding the after-market motor vehicle products in the recommended set of after-market motor vehicle products; and
wherein the business logic server uses the first set of customer preference information from the customer and the additional set of customer preference information from the customer to identify the set of after-market motor vehicle products.

24. The system of claim 21, wherein the kiosk prompts the customer to input a level of interest in an after-market motor vehicle product and receives the level of interest in the after-market motor vehicle product from the customer.

25. The system of claim 21, wherein the system further comprises a manager console that a user uses to edit the identified set of after-market motor vehicle products before the customer console displays the set of after-market motor vehicle products.

26. The system of claim 25,
wherein the kiosk prompts the customer to input a name to be associated with the set of customer preference information collected from the customer;
wherein the manager console presents a set of names associated with set of customer preference information collected using the kiosk and receives input from the user that selects from the set of names a name associated with one of the sets of customer preference information; and
wherein the user utilizes the manager console to edit the selected one of the sets of customer preference information.

27. The system of claim 21, wherein the business logic server applies a set of business rules to the set of customer preference information to identify the set of after-market motor vehicle products.

28. The system of claim 27, wherein the business rules comprise condition-action rules.

29. The system of claim 21, wherein the business logic server uses the collected set of customer preference information from the customer and a set of customer preference information from another customer to identify the set of after-market motor vehicle products that the customer is likely to be interested in purchasing along with the motor vehicle.

30. The system of claim 21, wherein the business logic server uses the collected set of customer preference information to identify a package of after-market motor vehicle products.

31. The system of claim 21, wherein the business logic server uses the collected customer purchase information to refine which after-market motor vehicle products the business logic server identifies given the collected set of customer preference information.

32. The system of claim 21,
wherein the business logic server uses the collected set of customer preference information to select presentation frequencies for advertisements for after-market motor vehicle products; and
wherein the system further comprises a digital signage unit to present the advertisements for the after-market motor vehicle products according to the presentation frequencies selected for the advertisements in the motor vehicle dealership.

33. A motor vehicle dealership comprising:
a computer kiosk to collect from a customer a set of customer preference information regarding after-market motor vehicle products during a sales process for a motor vehicle, wherein the computer kiosk is installed in a motor vehicle dealership;
a business logic server to use the collected set of customer preference information to automatically identify a set of after-market motor vehicle products that the customer is likely to be interested in purchasing along with the motor vehicle;
a customer console to display the identified set of after-market motor vehicle products and to collect customer purchase information that describes which after-market motor vehicle products the customer chose to purchase along with the motor vehicle; and
a computer network to facilitate communication among the kiosk, the business logic server, and the customer console.
